(19) United States
(12) Patent Application Publication
(10) Pub. No.: US 2022/0396919 A1
(43) Pub. Date: Dec. 15, 2022

(54) Coating Formulations

(71) Applicant: Nano and Advanced Materials Institute Limited, Hong Kong (CN)

(72) Inventors: Wei LI, Hong Kong (CN); Jianli WANG, Hong Kong (CN); Yeuk Tin LAU, Hong Kong (CN)

(21) Appl. No.: 17/805,872

(22) Filed: Jun. 8, 2022

Related U.S. Application Data
(60) Provisional application No. 63/202,512, filed on Jun. 15, 2021.

(51) Int. Cl. D21H 19/62; C08G 77/24; C08G 77/06; C08K 3/36; C09D 7/61; C09D 7/40; C09D 7/20; C09D 183/08; C09D 5/00; D21H 21/16; D21H 19/40

(52) U.S. Cl. CPC D21H 19/62; C08G 77/24; C08G 77/06; C08K 3/36; C09D 7/61; C09D 7/67; C09D 7/20; C09D 183/08; C09D 5/00; D21H 21/16; D21H 19/40; C08K 2201/011; C08K 2201/005

(57) ABSTRACT

Provided herein are coating formulations useful for endowing substrates with hydrophobic, superhydrophobic, and/or oleophobic properties and methods of use thereof. The coating formulation can include alkylalkoxysilane, 1H,1H,2H,2H-perfluorooctyltriethoxysilane, nano-SiO₂, a crosslinking additive, and at least one solvent.

### CROSS-REFERENCE TO RELATED APPLICATIONS

This application claims the benefit of priority of U.S. Provisional Application No. 63/202,512, filed on Jun. 15, 2021, the contents of which are hereby incorporated by reference in their entirety for all purposes.

### TECHNICAL FIELD

The present disclosure generally relates to coating formulations useful for preparing hydrophobic, superhydrophobic and/or oleophobic coatings, which can be applied to the surface of substrates, such as paper, their methods of preparation and application thereof.

### BACKGROUND

Since natural biodegradable material-paper is generally highly oleophilic, for applications in which an oleophobic surface is required, the surface must be covered or treated to product an oleophobic coating. The key index of oleophobic coatings is the contact angle of oil on the coating surface, which should be greater than 90°. Under such circumstances, penetration of the surface of the coating by the oil is at least partially inhibited.

Inspired by the self-cleaning and water-repellent properties of the lotus leaf and the leg of the water strider in nature, artificial superhydrophobic surfaces have generated extensive attention in academia and industry. It is well known that combining the appropriate surface roughness and/or materials with a low surface energy is a successful strategy for preparing superhydrophobic surfaces. The most common way to reduce the surface energy is to add fluorine-containing materials to the formula. In order to obtain micro- and nanoscale surface features, one common method is to add nano materials into the coating formula. However, the mechanical strength of such coatings can be less than optimal.

Conventional superhydrophobic and oleophobic coatings are generally applied to the surface of glass, steel, and plastic. However, there are far fewer reports of applying coatings to paper substrates. Applying superhydrophobic and oleophobic coatings to thin paper substrates can be problematic due to the formation of ripples and/or other imperfects in the paper substrate.

There thus exists a need for improved hydrophobic, superhydrophobic and/or oleophobic coating formulations that address or overcome at least some of the challenges described above.

### SUMMARY

Provided herein are coating formulations, which can be used on substrates, such as paper and which can provide large water and oil contact angles with high mechanical strength. Advantageously, the coating formulations can be applied to thin paper substrates without causing imperfections, such as ripples.

In a first aspect, provided herein is a coating formulation comprising an alkylalkoxysilane, 1H,1H,2H,2H-perfluorooctyltriethoxysilane (FAS), nano-SiO₂, a crosslinking additive, and at least one solvent, wherein the mass ratio of the alkylalkoxysilane, nano-SiO₂, FAS, and the crosslinking additive is between 20-65:1-10:2-10:1-10, respectively.

In certain embodiments, the crosslinking additive is selected from the group consisting of methyltrimethoxysilane, polydimethylsiloxane, polydiethylsiloxane, styrene, 1,3-butadiene, 2-methyl-1,3-butadiene, N,N-methylenebisacrylamide, dibenzoyl peroxide, 2,2′-azobis(2-methylpropionitrile, ammonium ceric nitrate, dicumyl peroxide, di-tert-butyl peroxide, p-dipropylbenzene hydroperoxide, a phenolic resin, an amino resin, a diisocyanate, a polyisocyanate, an anlkyd resin, alumina, hydrated silica, titanium dioxide, magnesium oxide, maleic anhydride, o-phthalic anhydride, tetrahydrophthalic anhydride, tetrahydromethylphthalic anhydride, hexahydrophthalic anhydride, 2-ethyl-4-methylimidazole, 2-phenylimidazole, 2-isopropylimidazole, triethylenetetramine, N,N-dimethyl-1,3-propanediamine, 3-diethylaminopropylamine, aluminum chloride, zinc chloride, poly(propylene glycol) diglycidyl ether, poly(ethylene glycol) diglycidyl ether, and combinations thereof.

In certain embodiments, the crosslinking additive is polymethyltrimethoxysilane, N,N-methylenebisacrylamide, dibenzoyl peroxide, phenolic resin, alumina, hydrated silica, maleic anhydride, or 2-ethyl-4-methylimidazole.

In certain embodiments, the crosslinking additive is hydrated silica.

In certain embodiments, the alkylalkoxysilane is R¹Si(OR²)₃, wherein R¹ is C₁-C₆ alkyl; and each R² for each instance is independently C₁-C₆ alkyl.

In certain embodiments, the alkylalkoxysilane is methyltriethoxysilane (MTES).

In certain embodiments, the nano-SiO₂ has an average particle size of 1-100 nm.

In certain embodiments, the at least one solvent is selected from an alcohol, a ketone, water, a carboxylic acid, and combinations thereof.

In certain embodiments, the at least one solvent is selected from a C₁-C₄ alcohol, C₃-C₅ ketone, C₂-C₃ carboxylic acid, and combinations thereof.

In certain embodiments, the coating formulation comprises MTES, FAS, nano-SiO₂, a crosslinking additive selected from the group consisting of alumina and hydrated silica, and at least one solvent, wherein the mass ratio of the MTES, nano-SiO₂, FAS, and the crosslinking additive is between 50-65:5-10:2-6:6-8, respectively.

In certain embodiments, the least one solvent is ethanol, acetic acid, acetone, and water.

In certain embodiments, the mass ratio of the MTES, nano-SiO₂, FAS, the crosslinking additive, and at least one solvent is between 50-65:5-10:2-6:6-8:30-75, respectively.

In certain embodiments, the coating formulation comprises MTES, FAS, nano-SiO₂, hydrated silica, and at least one solvent, wherein the at least one solvent is ethanol, acetic acid, acetone, and water and the mass ratio of the MTES, nano-SiO₂, FAS, and the crosslinking additive is between 50-65:5-10:2-6:6-8:30-40, respectively.

In certain embodiments, the ethanol, acetic acid, acetone, and water are present in a volume ratio in the at least one solvent in a 45-50:3-5:3-5:40-45, respectively.

In a second aspect, provided herein is a kit comprising the coating formulation described herein, wherein the kit comprises a first container comprising the alkylalkoxysilane, FAS, and optionally the at least one solvent; and a second container comprising the crosslinking additive, nano-SiO₂, and at least one solvent.

In a third aspect, provided herein is a method of applying the coating formulation of described herein to a substrate, the method comprising: depositing a layer of the coating formulation on a surface of the substrate and curing the layer of the coating formulation.

In certain embodiments, the step of curing the layer of the coating formulation comprises heating the layer of the coating formulation at a temperature between 40-120° C.

In certain embodiments, the substrate is a paper substrate.

In certain embodiments, the step of depositing a layer of the coating formulation comprises depositing the coating formulation on the surface of the substrate at a concentration of 0.5-1.5 g/m².

In a fourth aspect, provided herein is a coated paper substrate prepared according to the methods described herein, wherein the coated paper has a water contact angle of at least 150° and an olive oil contact angle of at least 130°.

The coatings described herein comprise nano-SiO₂ to provide surface coatings with nano-scale features, and FAS is used to reduce surface energy of coatings, so as to obtain coatings that exhibit both superhydrophobic and oleophobic properties.

The coatings described herein can be used on the surface of paper substrates in place of polyethylene (PE) laminated paper. Compared with the traditional PE laminated paper, the amount of coating materials used in the methods described herein can be as low as 0.5-1.5 g/m², which is far less than the amount of PE of 10-30 g/m² typically used for PE lamination of paper. Additionally, the method for applying the coatings described herein is simple, requiring only a spraying the coating, and does not need a series of lamination lines such as twin-screw coating machine for preparing the laminated paper. The drying temperature and film forming time can be as little as one hour at 100° C.

The superhydrophobic and oleophobic coatings can comply with the restriction of hazardous substances (RoHS) tests, and the coating can be used on paper substrates. In addition, the coating can also be used in connection with a variety of material surfaces, such as glass, steel, plastic, etc. while still providing the coated substrates with good superhydrophobic and oleophobic properties, as well as self-cleaning function.

After the coating of the optimization formula is sprayed on the coated paper, the water contact angle of the coated paper reaches 155° and the oil contact angle of the paper reaches 131° (FIG. 2), respectively. The results show the coating has good hydrophobic & oleophobic properties, and can be used as the substitute of laminated paper, such as in the field of wallpaper, wrapping paper etc.

### BRIEF DESCRIPTION OF THE DRAWINGS

The above and other objects and features of the present disclosure will become apparent from the following description of the disclosure, when taken in conjunction with the accompanying drawings.

FIG. 1 depicts an exemplary reaction sequence for preparing certain embodiments of the coating described.

FIG. 2 depicts a table that shows value and testing photos of contact angle for paper.

FIG. 3 depicts graphs showing the effect of the FAS content on the contact angles of the coating. SiO₂: 6%, (A) wet weight of the coating: 6 g/m2, dry weight of the coating: 1.5 g/m2; (B) wet weight of the coating: 2 g/m2, dry weight of the coating: 0.5 g/m2; and a table showing the components of the coatings tested in (A) and (B).

FIG. 4 depicts graphs showing the effect of the SiO₂ content on the contact angles of the coating. Wet weight of the coating: 6 g/m², Dry weight of the coating: 1.5 g/m²; (A) FAS: 10%; (B) FAS: 4%; and a table showing the components of the coatings tested in (A) and (B).

FIG. 5 depicts a graph showing the effect of coating dry weight to contact angle of the coating and a table showing the components of the coatings tested.

FIG. 6 depicts tables showing (A) the results of coatings having different amounts of MTES on the water and olive oil contact angle and mechanical strength of the coatings; and (B) a table showing the components of the coatings tested in (A).

FIG. 7 depicts a table showing (A) the mechanical strength of coatings having different crosslinking agents or additives; (B) is a legend categorizing the mechanical properties of the coatings in (A); and (C) tables showing the components of the coatings tested in (A).

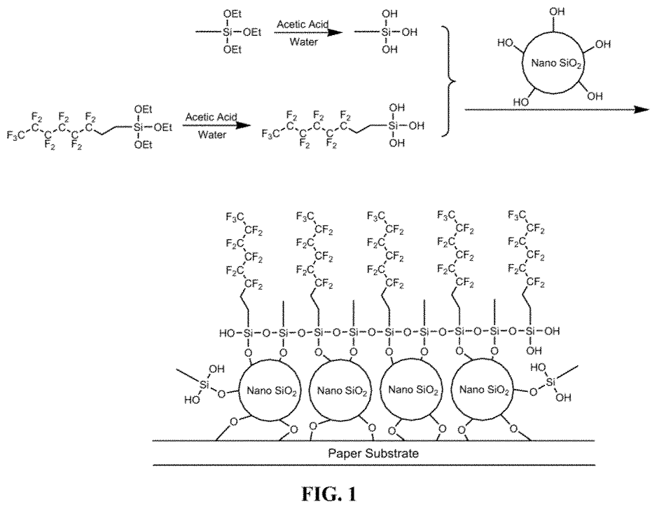

### DETAILED DESCRIPTION

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

It should be understood that the order of steps or order for performing certain actions is immaterial so long as the present teachings remain operable. Moreover, two or more steps or actions may be conducted simultaneously.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The present disclosure provides coating formulations that are useful for preparing superhydrophobic and oleophobic coatings on a substrate, such as a paper substrate. The coating formulation can comprise an alkylalkoxysilane, FAS, nano-SiO₂, a crosslinking additive, and at least one solvent. In certain embodiments, the mass ratio of the alkylalkoxysilane, nano-SiO₂, FAS, and the crosslinking additive in the coating formulation is between 20-65:1-10:2-10:1-10, respectively.

The alkylalkoxysilane can be represented by the formula R¹Si(OR²)₃, wherein R¹ is C₁-C₆ alkyl, C₁-C₅ alkyl, C₁-C₄ alkyl, C₁-C₃ alkyl, C₁-C₂ alkyl, or methyl; and each R² for each instance is independently C₁-C₆ alkyl, C₁-C₅ alkyl, C₁-C₄ alkyl, C₁-C₃ alkyl, C₁-C₂ alkyl, or methyl. In certain embodiments, the alkylalkoxysilane is R¹Si(OR²)₃, wherein R¹ is C₁-C₂ alkyl; and wherein R² is C₁-C₂ alkyl. In certain embodiments, the alkylalkoxysilane is MTES.

The crosslinking additive can be any material capable of reacting with at least one of the alkylalkoxysilane, FAS, nano-SiO₂, or substrate. Exemplary classes of crosslinking additives include, but are not limited to radical initiators, polymers comprising one or more reactive groups, monomers comprising one or more reactive groups, Lewis acids, Lewis bases, metal oxides, metalloid oxides, and combinations thereof.

Crosslinking additives useful in the coating formulations described herein include, but are not limited, to polydimethylsiloxane, polydiethylsiloxane, styrene, 1,3-butadiene, 2-methyl-1,3-butadiene, N,N′-methylenebisacrylamide, dibenzoyl peroxide, 2,2′-azobis(2-methylpropionitrile, ammonium ceric nitrate, dicumyl peroxide, di-tert-butyl peroxide, p-dipropylbenzene hydroperoxide, phenolic resin, amino resin, isocyanate, alkyd resin, alumina, silica, titanium dioxide, magnesium oxide, maleic anhydride, o-phthalic anhydride, tetrahydrophthalic anhydride, tetrahydromethylphthalic anhydride, hexahydrophthalic anhydride, 2-ethyl-4-methylimidazole, 2-phenylimidazole, 2-isopropylimidazole, triethylenetetramine, N,N-dimethyl-1,3-propanediamine, 3-diethylaminopropylamine, aluminum chloride, zinc chloride, poly propylene glycol diglycidyl ether, and poly glycol diglycidyl ether. In certain embodiments, the crosslinking additive is polymethyltrimethoxysilane, N,N′-methylenebisacrylamide, dibenzoyl peroxide, phenolic resin, alumina, hydrated silica, maleic anhydride, or 2-ethyl-4-methylimidazole. In certain embodiments, the crosslinking additive is alumina or hydrated silica.

In certain embodiments, the hydrated silica can be represented by the formula mSiO₂.nH₂O, wherein m is 1-4; and n is 0.1-4. In certain embodiments, m is 1-4, 1-3, or 1-2 and n is 0.1-4, 0.1-3, 0.1-2, 0.1-1, or 0.1-0.5. In certain embodiments, the hydrated silica is in the form of particles, wherein each particle comprises a core of predominantly SiO₂, which is surrounded by a shell of mSiO₂.nH₂O.

The hydrated silica can have an average particle size between 1-100 nm, 5-100 nm, 5-90 nm, 5-80 nm, 5-70 nm, 5-60 nm, 5-50 nm, 5-40 nm, 5-30 nm, 10-30 nm, 15-25 nm, or about 20 nm.

The nano-SiO₂ can have an average particle size between 1-100 nm, 5-100 nm, 5-90 nm, 5-80 nm, 5-70 nm, 5-60 nm, 5-50 nm, 5-40 nm, 5-30 nm, 10-30 nm, 15-25 nm, or about 20 nm.

The alumina can have an average particle size between 1-100 nm, 5-100 nm, 5-90 nm, 5-80 nm, 5-70 nm, 5-60 nm, 5-50 nm, 5-40 nm, 5-30 nm, 10-30 nm, 15-25 nm, or about 20 nm.

The at least one solvent can be any solvent in which one or more of the components of the coating formulation are at least partially soluble and which has a boiling point below 140° C. The at least one solvent can be aqueous, organic, or a mixture thereof. The solvent can be water, alcohols, ketones, esters, ethers, water, carboxylic acids, and mixtures thereof. In certain embodiments, the at least one solvent is water, C₁-C₄ alcohol, C₃-C₅ ketones, C₃-C₅ esters, C₂-C₅ ethers, water, C₂-C₄ carboxylic acids, and mixtures thereof. Exemplary solvents, include but are not limited to methanol, ethanol, isopropanol, acetone, butanone, methyl acetate, ethyl acetate, diethyl ether, methyl tert-butyl ether, tetrahydrofuran, tetrahydropyran, acetic acid, propionic acid, and mixtures thereof. The at least one solvent can comprise water and optionally one or more other solvents described herein. In certain embodiments, the at least one solvent is water, acetic acid, ethanol, and acetone.

The coating formulation can contain the alkylalkoxysilane at a concentration between 20-57% m/m of. In certain embodiments, the coating formulation contains the alkylalkoxysilane at a concentration between 30-57% m/m, 40-57% m/m, 49-57% m/m, 52-57% m/m, or about 52% m/m.

The coating formulation can contain the FAS at a concentration between 1.8-7% m/m of. In certain embodiments, the coating formulation contains the FAS at a concentration between 1.8-5.3% m/m, 1.8-3.6% m/m, 3.6-5.3% m/m, or about 3.6% m/m.

The coating formulation can contain the nano-SiO₂ at a concentration between 1-8.8% m/m of. In certain embodiments, the coating formulation contains the nano-SiO₂ at a concentration between 1.8-8.8% m/m, 1.9-8.8% m/m, 2.8-8.8% m/m, 3.7-8.8% m/m, 4.6-8.8% m/m, 5.4-8.8% m/m, 5.4-8.8% m/m, or about 6.3% m/m.

The coating formulation can contain the crosslinking additive at a concentration between 1-7% m/m of. In certain embodiments, the coating formulation contains the crosslinking additive at a concentration between 2.8-7% m/m, 4.8-7% m/m, 4.8-5.6% m/m, or 5.6-7% m/m.

The coating formulation can contain the at least one solvent at a concentration between 30-40% m/m of. In certain embodiments, the coating formulation contains the at least one solvent at a concentration between 31-37% m/m, 32-37% m/m, 32-35% m/m.

The coating formulation can comprise the alkylalkoxysilane, nano-SiO₂, FAS, and the crosslinking additive in the coating formulation in a mass ratio between 20-65:1-10:2-10:1-10; 30-65:2-9:3-9:2-9; 40-65:3-9:4-9:2-8; 50-65:4-9:5-9:2-7; 55-65:5-8:6-9:3-6; 55-60:5-7:7-9:4-6, respectively.

In certain embodiments, the coating formulation comprises MTES (20-90% m/m), deionized water (0.05-40% m/m), acetic acid (0.05-10% m/m), crosslinking additives (1-30% m/m), ethanol (1-50% m/m) and acetone (0.05-10% m/m).

The present disclosure also provides a method for preparing the coating formulation described herein, the method comprising bringing into contact the alkylalkoxysilane, crosslinking additive, FAS, nano-SiO2, and at least one solvent thereby forming the coating formulation.

In certain embodiments, the coating formulation is prepared by a method comprising combining the alkylalkoxysilane, at least one solvent, and crosslinking additive thereby forming a first mixture; combining FAS and nano-SiO₂ with the first mixture thereby forming the coating formulation.

An exemplary method of preparing the coating formulation comprises combining the MTES, water, ethanol, acetic acid, and crosslinking additive at room temperature and stirring overnight until a clear solution is obtained. Then heat the solution at 70° C. in an oven for 10 hours. Cool down the solution to room temperature for at least 24 hours. Then add FAS (4-30%) and stir the solution with a magnetic stirrer at room temperature until a clear solution is obtained. Add nano-SiO₂ (4-30%) and ultrasonicate the solution in water bath until a homogenous solution is obtained.

Also provided herein is a method of applying the coating formulation described herein to a surface of a substrate, the method comprising depositing a layer of the coating formulation on a surface of the substrate and curing the layer of the coating formulation.

The coating formulation can be applied to a surface of a substrate using any method known in the art, such as spin coating, printing, print screening, spraying, painting, brushing, and dip coating. The coating formulation described herein can be applied to a surface of a substrate using a brush, blade, roller, sprayer (for example, air-assisted or airless, electrostatic), vacuum coater, curtain coater, flood coater, or any other means known in the art.

The coating formulation can be applied to a wide variety of surfaces such as, for example, the surface of substrates composed of paper, wood, concrete, cement, asphalt, metal (e.g., streel, aluminum alloy, etc), glass, gypsum, ceramic, ceramic tiles, plastic, plaster, masonry, resin, and roofing substrates such as asphaltic coatings, roofing felts, foamed polyurethane insulation. In certain embodiments, the substrate is paper, such as wallpaper, magazines, newspapers, wrapping paper, paper dishware (e.g., cups, plates, bowls, etc), and paper cutlery.

The coating formulation can be applied onto the surface of the substrate to obtain different spraying thickness by, e.g., adjusting the spraying wet weight of the coating formulation. The coating formulation can be applied to a substrate at a concentration of 0.5-1.5 g/m².

The layer of the coating formulation on the substrate can be cured at a temperature between 40-120° C., 50-120° C., 60-120° C., 70-120° C., 80-120° C., 90-120° C., 90-110° C., or about 100° C. The layer of the coating formulation on the substrate can be cured for between 10 minutes and 360 minutes, 30 minutes and 360 minutes, 30 minutes and 300 minutes, 30 minutes and 240 minutes, 30 minutes and 180 minutes, 30 minutes and 120 minutes, 45 minutes to 90 minutes, or about 60 minutes. In certain embodiments, the coating formulation is cured at about 100° C. for 60 minutes.

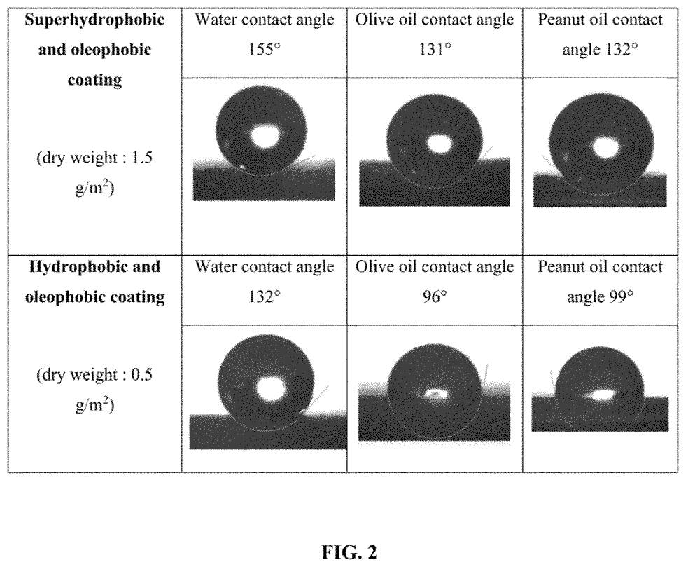

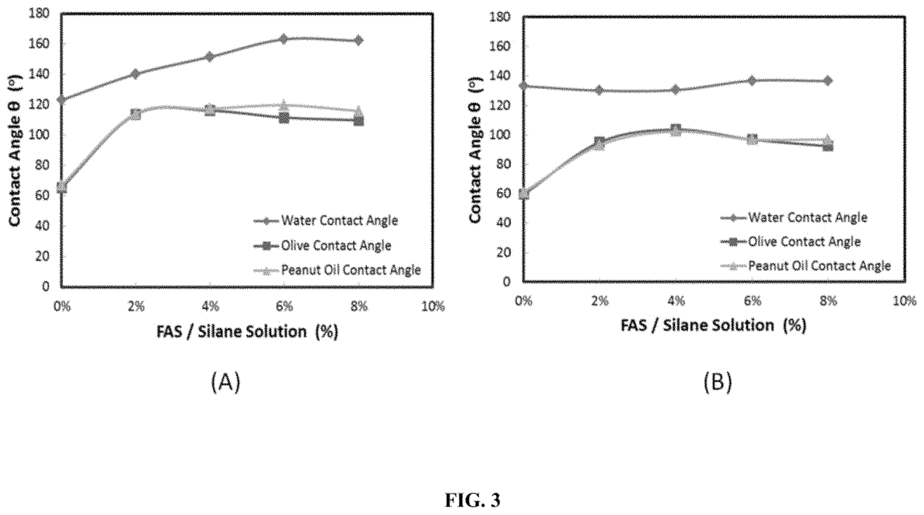

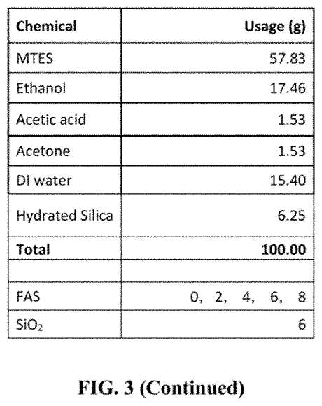

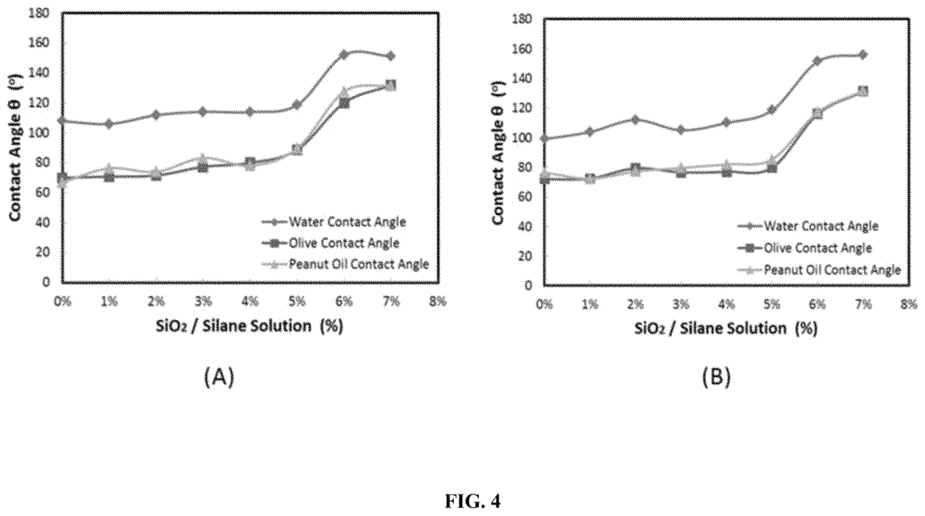

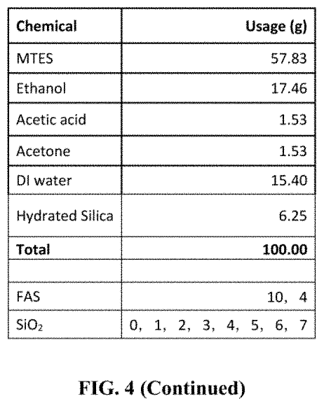

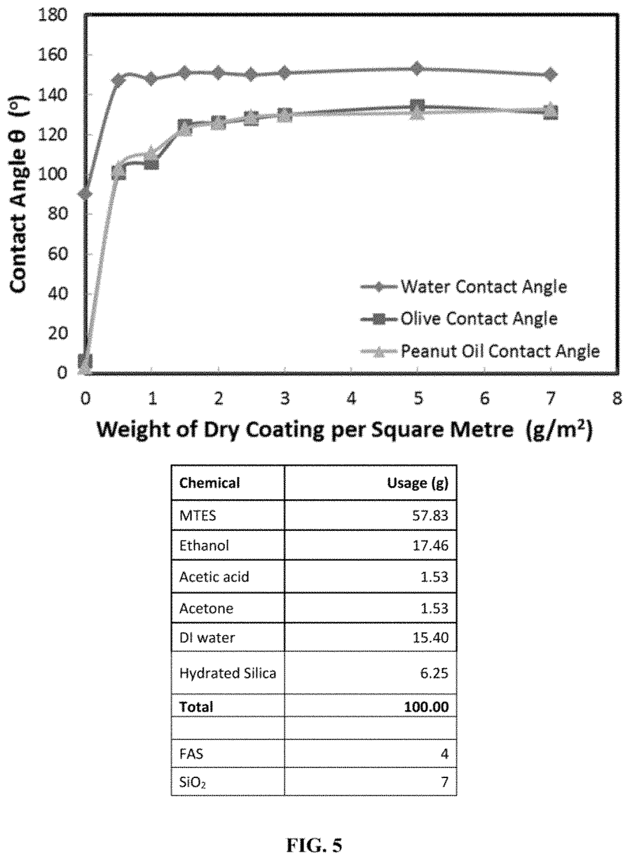

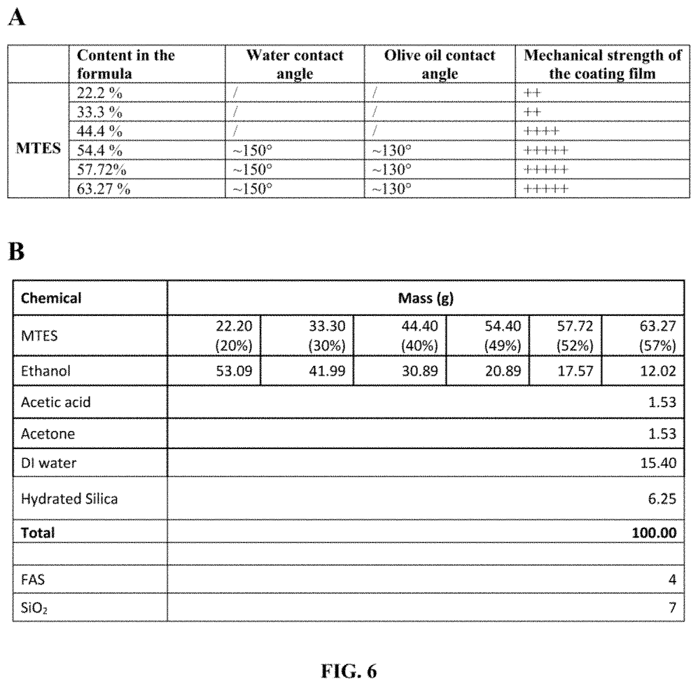

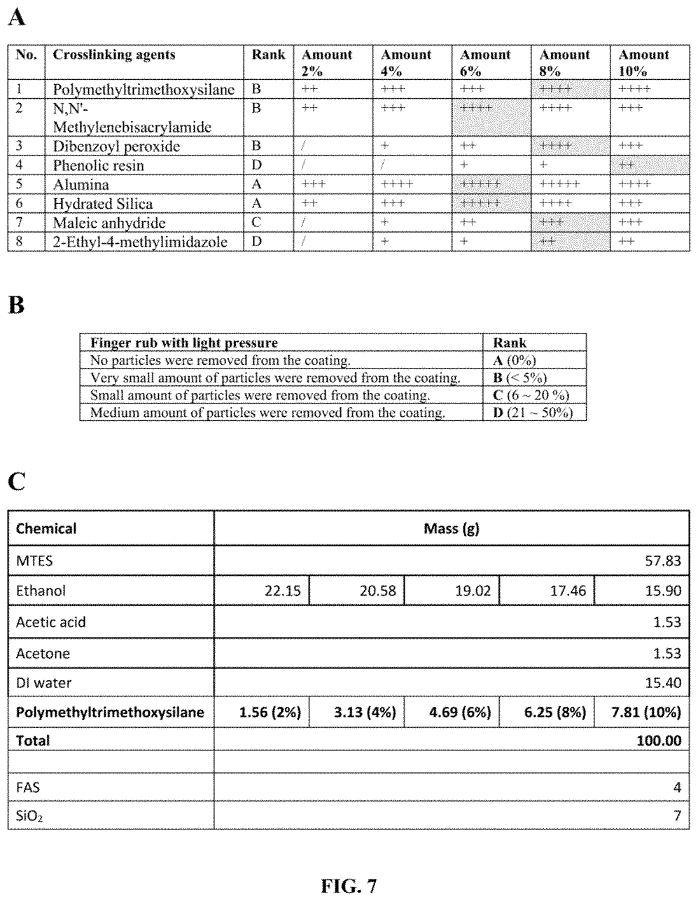

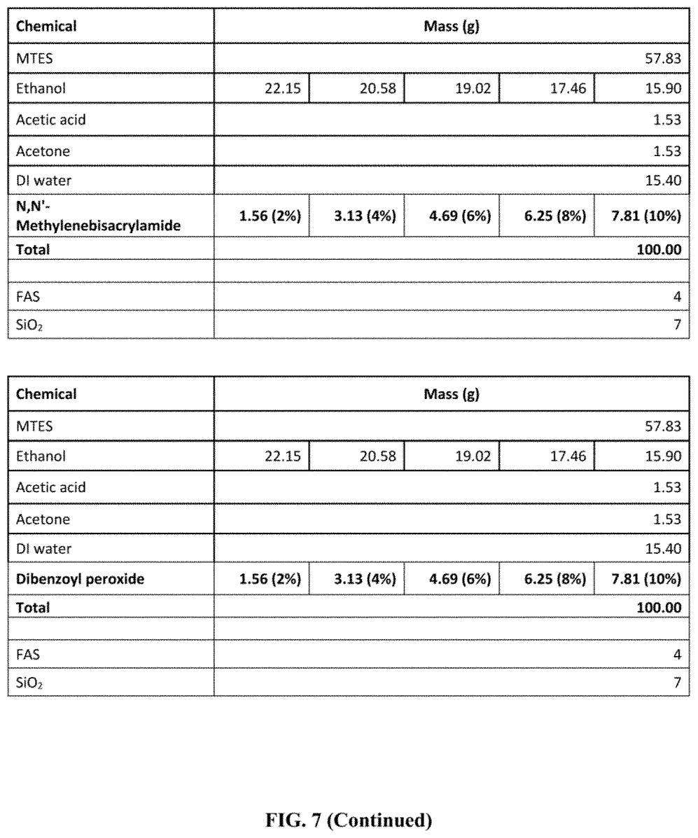

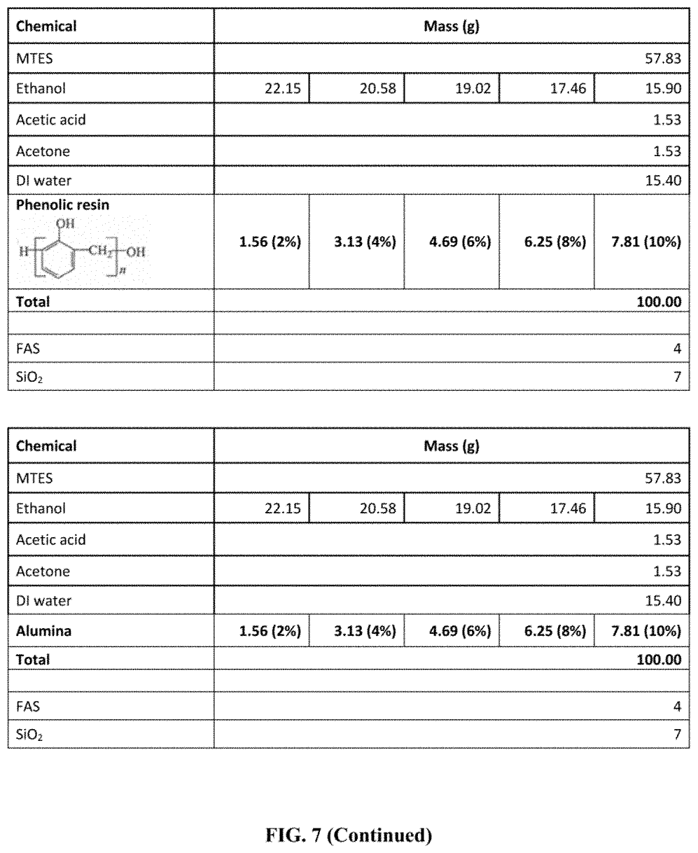

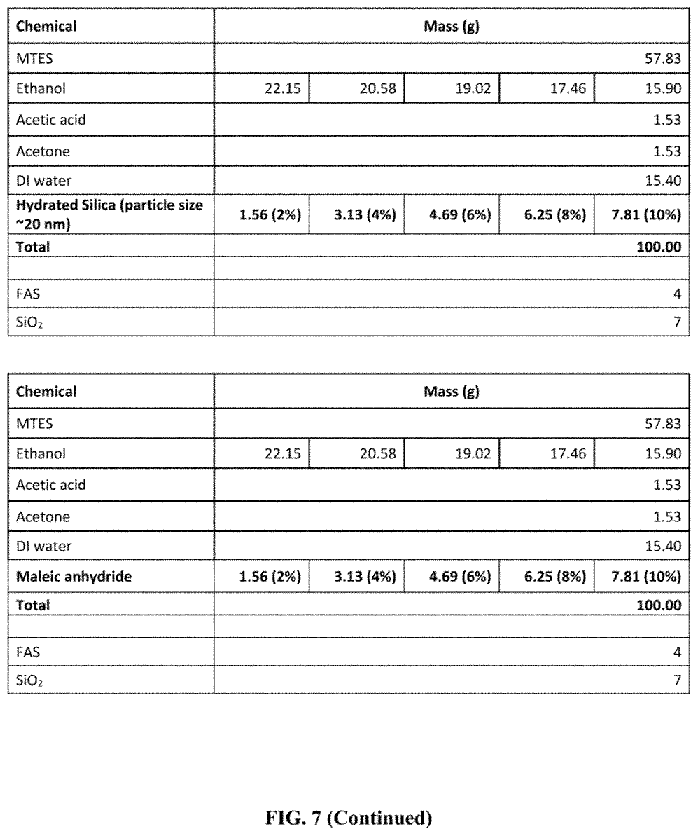

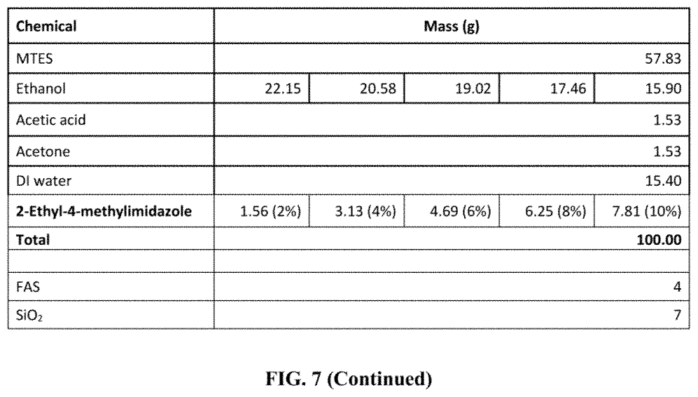

As demonstrated by the photographs in FIG. 2, the coated substrates prepared in accordance with the methods described herein can exhibit high water and oil contact angles, which endows the coated substrate with hydrophobic, oleophobic, and superhydrophobic properties.

The coated substrate can have a water contact angle of up to 155°. In certain embodiments, the coated substrate has a water contact angle of up to 100-155°, 110-155° 120-155°, 130-155°, 140-155°, or 150-155°, or about 155°.

The coated substrate can have an oil contact angle of up to 132°. In certain embodiments, the coated substrate has an oil contact angle of up to 100-132°, 110-132° 120-132°, 130-132°, or about 132°.

### EXAMPLES

### Example 1

A mixture was prepared by combining MTES 52%, DI water 14%, acetic acid 1%, crosslinking additives 6%, ethanol 16% and acetone 1%. Then the solution was stirred with a magnetic stirrer at room temperature overnight until obtain a clear solution was obtained. The solution was then heated for 10 hours at 70° C., then allowed to cool down to room temperature for at least 24 hours.

FAS 4% was added to the mixture and the solution was stirred with a magnetic stirrer at room temperature until a clear solution was obtained. Nano SiO₂ 6% was then added and the resulting mixture was ultrasonicated in a water bath until a homogenous mixture was obtained.

The mixture was sprayed onto the paper to obtain different spraying thickness adjusted by spraying different wet weight of mixture solutions. The coated paper was cured in an oven at 100° C. for 60 minutes.

The 1.5 g/m² dry weight superhydrophobic and oleophobic coating showed the contact angles 155°, 131° and 132°, for the media water, olive oil and peanut oil, respectively. The 0.5 g/m² dry weight superhydrophobic and oleophobic coating showed the contact angles 132°, 96° and 99°, for the media water, olive oil and peanut oil, respectively.

### Example 2

A mixture was prepared by combining MTES 49%, DI water 13%, acetic acid 1%, crosslinking additives 5%, ethanol 15% and acetone 1%. Then the solution was stirred with a magnetic stirrer at room temperature overnight until a clear solution was obtained. The solution was then heated at 70° C. for 10 hours, then allowed to cool down to room temperature for at least 24 hours.

FAS 9% was then added to the mixture and the solution was stirred with a magnetic stirrer at room temperature until obtain a clear solution was obtained. Nano SiO₂ 6% was then added and the mixture was ultrasonicated in a water bath until a homogenous mixture was obtained.

The mixture was sprayed onto the paper to obtain different spraying thickness adjusted by spraying different wet weight of mixture solutions. The coated paper was cured in an oven at 100° C. for 60 minutes.

The 1.5 g/m² dry weight superhydrophobic and oleophobic coating showed the contact angles 155°, 132° and 132°, for the media water, olive oil and peanut oil, respectively. The 0.5 g/m² dry weight superhydrophobic and oleophobic coating showed the contact angles 156°, 111° and 110°, for the media water, olive oil and peanut oil, respectively.

Compared with example 1, the increase of FAS in the formula increased both the water contact angle and the oil contact angle, especially when the layer was thin.

### Example 3

A mixture was prepared by combining MTES 55%, DI water 15%, acetic acid 1%, crosslinking additives 6%, ethanol 16%, and acetone 1%. Then the solution was stirred with a magnetic stirrer at room temperature overnight until obtain a clear solution was obtained. Then the solution was heated at 70° C. for 10 hours, then cooled down to room temperature for at least 24 hours.

FAS 4% was added to the mixture and the solution was stirred with a magnetic stirrer at room temperature until a clear solution was obtained. Nano SiO₂ 2% was then added and the resulting mixture was ultrasonicated in a water bath until obtain a homogenous mixture was obtained.

The mixture was sprayed onto the paper to obtain different spraying thickness adjusted by spraying different wet weight of mixture solutions. The coated paper was cured in an oven at 100° C. for 60 minutes.

The 1.5 g/m² dry weight superhydrophobic and oleophobic coating showed the contact angles 112°, 79° and 77°, for the media water, olive oil and peanut oil, respectively. The 0.5 g/m² dry weight superhydrophobic and oleophobic coating showed the contact angles 109°, 73° and 73°, for the media water, olive oil and peanut oil, respectively.

When the content of Nano SiO₂ is reduced to 2%, the performance of the coating cannot reach the standard of superhydrophobic and oleophobic (water contact angle >150°, oil contact angle >90°).

### Example 4

A mixture was prepared by combining MTES 54%, DI water 14%, acetic acid 1%, crosslinking additives 6%, ethanol 16% and acetone 1%. Then the solution was stirred with a magnetic stirrer at room temperature overnight until a clear solution was obtained. Then the solution was heated at 70° C. for 10 hours, then cooled down to room temperature for at least 24 hours.

FAS 2% was added to the mixture and the solution was stirred with a magnetic stirrer at room temperature until a clear solution was obtained. Nano SiO₂ 6% was added and the resulting mixture was ultrasonicated in a water bath until obtain a homogenous mixture was obtained.

The mixture was sprayed onto the paper to obtain different spraying thickness adjusted by spraying different wet weight of mixture solutions. The coated paper was cured in an oven at 100° C. for 60 minutes.

The 1.5 g/m² dry weight superhydrophobic and oleophobic coating showed the contact angles 140°, 113° and 114°, for the media water, olive oil and peanut oil, respectively. The 0.5 g/m² dry weight superhydrophobic and oleophobic coating showed the contact angles 130°, 95° and 93°, for the media water, olive oil and peanut oil, respectively.

When the content of FAS is reduced to 2%, the performance of the coating cannot reach the standard of superhydrophobic and oleophobic (water contact angle >150°, oil contact angle >90°).

What is claimed is:

1. A coating formulation comprising an alkylalkoxysilane, 1H,1H,2H,2H-perfluorooctyltriethoxysilane (FAS), nano-SiO₂, a crosslinking additive, and at least one solvent, wherein the mass ratio of the alkylalkoxysilane, nano-SiO₂, FAS, and the crosslinking additive is between 20-65:1-10:2-10:1-10, respectively.

2. The coating formulation of claim 1, wherein the crosslinking additive is selected from the group consisting of methyltrimethoxysilane, polydimethyl siloxane, polydiethylsiloxane, styrene, 1,3-butadiene, 2-methyl-1,3-butadiene, N,N-methylenebisacrylamide, dibenzoyl peroxide, 2,2′-azobis(2-methylpropionitrile, ammonium ceric nitrate, dicumyl peroxide, di-tert-butyl peroxide, p-dipropylbenzene hydroperoxide, a phenolic resin, an amino resin, a diisocyanate, a polyisocyanate, an anlkyd resin, alumina, hydrated silica, titanium dioxide, magnesium oxide, maleic anhydride, o-phthalic anhydride, tetrahydrophthalic anhydride, tetrahydromethylphthalic anhydride, hexahydrophthalic anhydride, 2-ethyl-4-methylimidazole, 2-phenylimidazole, 2-isopropylimidazole, triethylenetetramine, N,N-dimethyl-1,3-propanediamine, 3-diethylaminopropylamine, aluminum chloride, zinc chloride, poly(propylene glycol) diglycidyl ether, poly(ethylene glycol) diglycidyl ether, and combinations thereof.

3. The coating formulation of claim 1, wherein the crosslinking additive is polymethyltrimethoxysilane, N,N-methylenebisacrylamide, dibenzoyl peroxide, phenolic resin, alumina, hydrated silica, maleic anhydride, or 2-ethyl-4-methylimidazole.

4. The coating formulation of claim 1, wherein the crosslinking additive is hydrated silica.

5. The coating formulation of claim 1, wherein the alkylalkoxysilane is R¹Si(OR²)₃, wherein R¹ is C₁-C₆ alkyl; and each R² for each instance is independently C₁-C₆ alkyl.

6. The coating formulation of claim 1, wherein the alkylalkoxysilane is methyltriethoxysilane (MTES).

7. The coating formulation of claim 1, wherein the nano-SiO₂ has an average particle size of 1-100 nm.

8. The coating formulation of claim 1, wherein the at least one solvent is selected from an alcohol, a ketone, water, a carboxylic acid, and combinations thereof.

9. The coating formulation of claim 1, wherein the at least one solvent is selected from a C₁-C₄ alcohol, C₃-C₅ ketone, C₂-C₃ carboxylic acid, and combinations thereof.

10. The coating formulation of claim 1, wherein the coating formulation comprises MTES, FAS, nano-SiO₂, a crosslinking additive selected from the group consisting of alumina and hydrated silica, and at least one solvent, wherein the mass ratio of the MTES, nano-SiO₂, FAS, and the crosslinking additive is between 50-65:5-10:2-6:6-8, respectively.

11. The coating formulation of claim 10, wherein the least one solvent is ethanol, acetic acid, acetone, and water.

12. The coating formulation of claim 11, wherein the mass ratio of the MTES, nano-SiO₂, FAS, the crosslinking additive, and at least one solvent is between 50-65:5-10:2-6:6-8:30-75, respectively.

13. The coating formulation of claim 1, wherein the coating formulation comprises MTES, FAS, nano-SiO₂, hydrated silica, and at least one solvent, wherein the at least one solvent is ethanol, acetic acid, acetone, and water and the mass ratio of the MTES, nano-SiO₂, FAS, and the crosslinking additive is between 50-65:5-10:2-6:6-8:30-40, respectively.

14. The coating formulation of claim 13, wherein the ethanol, acetic acid, acetone, and water are present in a volume ratio in the at least one solvent in a 45-50:3-5:3-5:40-45, respectively.

15. A kit comprising the coating formulation of claim 1, wherein the kit comprises a first container comprising the alkylalkoxysilane, FAS, and optionally the at least one solvent; and a second container comprising the crosslinking additive, nano-SiO₂, and at least one solvent.

16. A method of applying the coating formulation of claim 1 to a substrate, the method comprising: depositing a layer of the coating formulation on a surface of the substrate and curing the layer of the coating formulation.

17. The method of claim 16, wherein the step of curing the layer of the coating formulation comprises heating the layer of the coating formulation at a temperature between 40-120° C.

18. The method of claim 16, wherein the substrate is a paper substrate.

19. The method of claim 17, wherein the step of depositing a layer of the coating formulation comprises depositing the coating formulation on the surface of the substrate at a concentration of 0.5-1.5 g/m².

20. A coated paper substrate prepared according to the method of claim 18, wherein the coated paper has a water contact angle of at least 150° and an olive oil contact angle of at least 130°.
